(19) United States
(12) Patent Application Publication
(10) Pub. No.: US 2008/0168125 A1
(43) Pub. Date: Jul. 10, 2008

(54) METHOD AND SYSTEM FOR PRIORITIZING REQUESTS

(76) Inventors: WEN-TZER THOMAS CHEN, Austin, TX (US); Men-Chow Chiang, Austin, TX (US); William A. Maron, Austin, TX (US); Mysore Sathyanarayana Srinivas, Austin, TX (US)

Correspondence Address: IBM CORP (YA);C/O YEE & ASSOCIATES PC, P.O. BOX 802333, DALLAS, TX, 75380, US

(21) Appl. No.: 11/621,200

(22) Filed: Jan. 9, 2007

(51) Int. Cl. G06F 15/16

(52) U.S. Cl. 709/202

(57) ABSTRACT

A system for prioritizing resource requests. One or more resource requests are received. The one or more resource requests are prioritized in a queue according to a priority attribute that is associated with each of the one or more resource requests. A resource request with a highest priority in the queue is selected and processed. Then, a response to the resource request with the highest priority is sent.

### BACKGROUND

1. Field of the Invention

The present application relates generally to an improved data processing system. More specifically, the present invention is directed to a computer implemented method, system, and computer usable program code for prioritizing resource requests according to priority attributes provided by the resource requester.

2. Description of the Related Art

Today, most computers are connected to some type of network. A network allows a computer to share information with other computer systems. The Internet is one example of a computer network. The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The Internet uses a set of protocols called transmission control protocol/Internet Protocol (TCP/IP).

Client/server describes the relationship between two computer programs in which one program, the client, makes a service or resource request from another program, the server, which fulfills the request. Although programs within a single computer may use the client/server idea, the client/server idea is more important in a network environment. In a network environment, such as the Internet, the client/server model provides a convenient way to interconnect programs that are distributed efficiently across different locations. Computer transactions using the client/server model are very common.

For example, to check your bank account from your computer, a client program in your computer forwards your request to a server program at the bank. That program may in turn forward the request to its own client program that sends a request to a database server at another bank computer to retrieve your account balance. The balance is returned back to the bank data client, which in turn serves it back to the client in your personal computer, which displays the information for you.

When a multi-threaded application running on an application server issues a request to acquire a resource from a resource server via a network, the multi-threaded application is required to make a choice. The multi-threaded application may either let the thread issuing the request spin-wait, which holds the processor until the issuing thread receives a reply from the resource server, or cede the processor by means of a context-switch, which allows the multi-threaded application to schedule another thread to execute on the processor while the issuing thread waits for the reply from the resource server. While spin-waiting may result in better resource server response time, the multi-threaded application's throughput may suffer from wasting processor cycles in spin-wait. Even though context-switching utilizes processor cycles more efficiently, context-switching creates more processor overhead. In addition, context-switching back to the requesting thread when the reply finally comes back from the resource server later, also increases processor overhead.

Static timing analysis may determine, even without resource request contention at the resource server, that spin-wait minimum latency is too long and that immediate context-switching upon sending a resource request is the best strategy. But, even if static timing analysis determines that the spin-wait minimum latency is less than the context-switching time, it may not always be favorable to use the spin-wait strategy. The reason for this is because the dynamic latency of the resource request may vary significantly due to queuing delay at the resource server. This queuing delay is created because the resource server is processing resource requests from multiple application servers.

Therefore, it would be beneficial to have an improved computer implemented method, system, and computer usable program code for prioritizing resource requests according to priority attributes provided by the resource requester.

### SUMMARY

Illustrative embodiments provide a computer implemented method, system, and computer usable program code for prioritizing resource requests. One or more resource requests are received. The one or more resource requests are prioritized in a queue according to a priority attribute that is associated with each of the one or more resource requests. A resource request with a highest priority in the queue is selected and processed. Then, a response to the resource request with the highest priority is sent.

### BRIEF DESCRIPTION OF THE DRAWINGS

The novel features believed characteristic of the illustrative embodiments are set forth in the appended claims. The illustrative embodiments themselves, however, as well as a preferred mode of use, further objectives and advantages thereof, will best be understood by reference to the following detailed description of the illustrative embodiments when read in conjunction with the accompanying drawings, wherein:

FIG. 1 is a pictorial representation of a network of data processing systems in which illustrative embodiments may be implemented;

FIG. 2 is a block diagram of a data processing system shown in which illustrative embodiments may be implemented;

FIG. 3 is a block diagram of a data processing system in accordance with an illustrative embodiment;

FIG. 4 is a flowchart illustrating an exemplary process for prioritizing resource requests in accordance with an illustrative embodiment; and

FIG. 5 is a flowchart illustrating an exemplary process for sending a resource request in accordance with an illustrative embodiment.

### DETAILED DESCRIPTION OF THE PREFERRED EMBODIMENT

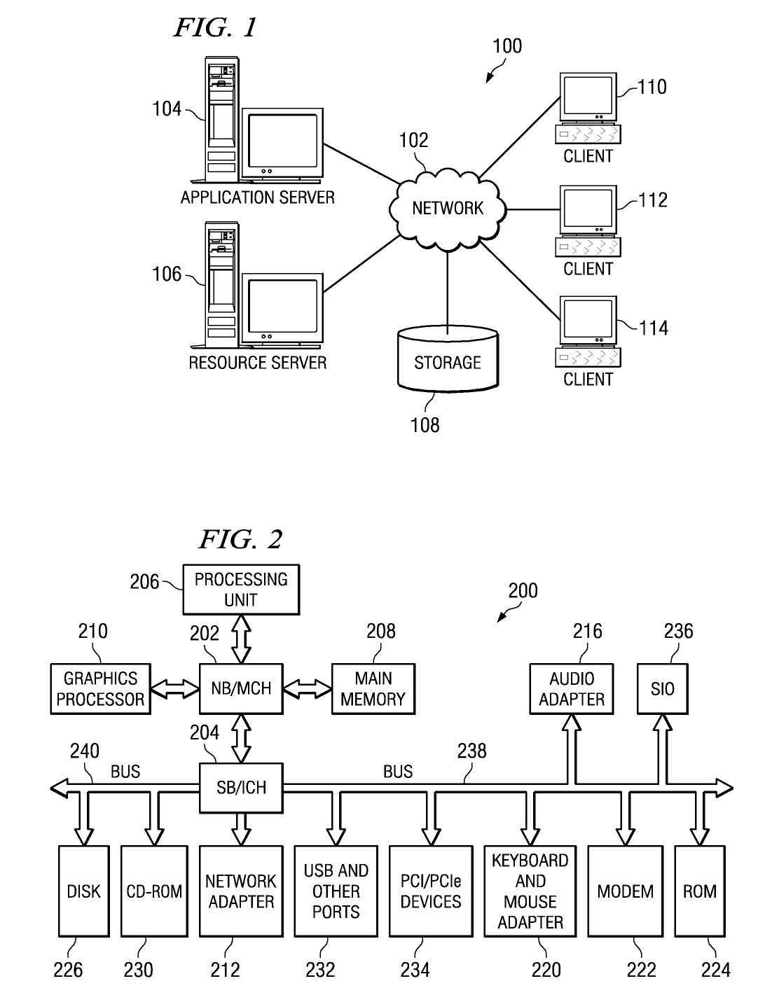

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between the various computers and other devices connected together within network data processing system 100. Network 102 may include connections, such as wire, wireless communication links, or fiber optic cables.

In the depicted example, application server 104 and resource server 106 connect to network 102, along with storage unit 108. Application server 104 is a server computer dedicated to running one or more software applications. In addition, application server 104 may, for example, deliver these one or more software applications to client computers, such as clients 110, 112, and 114.

These one or more software applications may, for example, be multi-threaded applications. The term “thread” is short for thread of execution. Threads are a way for an application to split itself into two or more simultaneously executing tasks. Multi-threading generally occurs by time slicing, wherein a single processor switches between different threads. This process of the processor switching between different threads is known as context-switching. Software and/or hardware may perform this context-switching process.

Resource server 106 is a server computer dedicated to providing resources for resource requests from an application or thread executing on application server 104. However, it should be noted that resource server 106 is not limited to only providing resources for resource requests from applications or threads executing on application server 104. Resource server 106 may, for example, provide resources for resource requests from other data processing systems, such as clients 110, 112, and 114, in addition to, or instead of, application server 104.

Clients 110, 112, and 114 connect to network 102. In addition, clients 110, 112, and 114 may, for example, be personal computers or network computers. In this illustrative example, application server 104 provides data, such as boot files, operating system images, and applications to clients 110, 112, and 114. Further, clients 110, 112, and 114 are clients to application server 104 in this example. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, LAN adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as HDD 226, and may be loaded into main memory 208 for execution by processing unit 206. The processes of the illustrative embodiments may be performed by processing unit 206 using computer implemented instructions, which may be located in a memory such as, for example, main memory 208, ROM 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus, and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Illustrative embodiments provide a computer implemented method, system, and computer usable program code for prioritizing resource requests. A resource server utilizes a request priority unit to receive one or more resource requests from applications or threads of a multi-threaded application(s) executing on an application server and/or a client device. It should be noted that the operating system of the application server and/or client devices is a special-type of multi-threaded application, which manages threads from single-thread applications and multi-threaded applications. A major difference between the operating system and the user applications, which the operating system manages, is that the operating system is more privileged than the user applications and may overwrite user application spin-wait and context-switch decisions based on a more global overview of system performance optimization. Therefore, the operating system, as well as the user applications, may benefit from utilizing illustrative embodiments.

The request priority unit prioritizes the one or more resource requests in a queue according to a priority attribute associated with each of the one or more resource requests. However, it should be noted that illustrative embodiments are not restricted to utilizing only one queue. Illustrative embodiments may utilize a plurality of queues to queue incoming resource requests.

A requester, which is the application or thread requesting the resource from the resource server, associates the priority attribute with the resource request. The priority attribute, which may, for example, be a bit, identifies the resource request as a synchronous or asynchronous resource request. A synchronous resource request spin-waits for a response from the resource server. In other words, the application or thread executing on the application server, which issues the synchronous resource request, “holds” the processor or “blocks” other applications or threads from executing on the processor, until the response is received from the resource server. In contrast, the asynchronous resource request context-switches immediately after issuing the resource request. In other words, the application or thread executing on the application server, which issues the asynchronous resource request, “cedes” or surrenders the processor immediately after issuing the resource request in order that other applications or threads may execute on the processor while the issuing thread waits for the response.

In response to selecting a resource request with the highest priority in the queue, the request priority unit processes the resource request with the highest priority. After processing the resource request with the highest priority, the request priority unit sends the response to the issuing application or thread requesting the resource. Subsequent to, or concurrent with, sending the response, the request priority unit re-prioritizes any remaining resource requests in the queue according to a priority policy.

The priority policy is a procedure for re-prioritizing resource requests in the queue. For example, the priority policy may include procedures, such as increase the priority of spin-wait resource requests, decrease the priority of context-switch resource requests, and progressively increase the priority of long-waiting resource requests. A long-waiting resource request is a resource request that remains in the queue for longer than a pre-determined amount of time, such as, for example, 10 milliseconds (ms), 100 ms, 10 seconds (sec), or 100 sec, without being selected for processing. However, it should be noted that a user or system administrator may set the pre-determined amount of time at any desired time value.

Also, it should be noted that the resource server prioritizes resource requests based on as many attribute values as possible if the attribute values can raise the overall performance of the data processing system. Further, there may be times when multiple resource requests within the queue have the same priority level. In the case of multiple resource requests having the same priority level within the queue, the resource server uses a first in first out (FIFO) policy. In other words, the first resource request in the queue with that same priority level is the first resource request that the resource server processes. However, the policy of progressively increasing the priority of long-waiting resource requests may modify the FIFO policy.

Thus, illustrative embodiments allow a requester, such as an application or thread, to influence the resource server's scheduling priority of resource requests. This influence on the scheduling priority by the requester may increase the data processing system's throughput and productivity. Also, this requester influence increases the data processing system's flexibility by allowing for scheduling priority changes in the resource server by the requester.

For example, when the default resource request scheduling priority scheme of the resource server is not appropriate for an application server, illustrative embodiments may provide increased flexibility for the application server. There are circumstances when the application server may want to influence the scheduling priority scheme of the resource server in order for the application server to have a somewhat different scheduling priority scheme from other application servers, either permanently or temporarily.

For example, if an application server is much faster than other application servers making resource requests of the resource server, the faster application server may achieve the best throughput by context-switching on every resource request. By associating a priority attribute, which indicates whether the resource request is synchronous (spin-wait) or asynchronous (context-switch), with each resource request sent to the resource server, the application server informs the resource server of the type of resource request the application server sent. This priority attribute information allows the resource server to, for example, reduce the scheduling priority of these asynchronous requests or equivalently increase the scheduling priority of other synchronous requests.

Alternatively, a small application server may have only one thread or very few threads to run. In this situation, the small application server may achieve the best throughput by spin-waiting on every resource request regardless of long or short response times. Consequently, the resource server, knowing that the small application server is spin-waiting on every resource request, may increase the scheduling priority of these synchronous requests because increasing the scheduling priority of these requests significantly increases the small application server's performance.

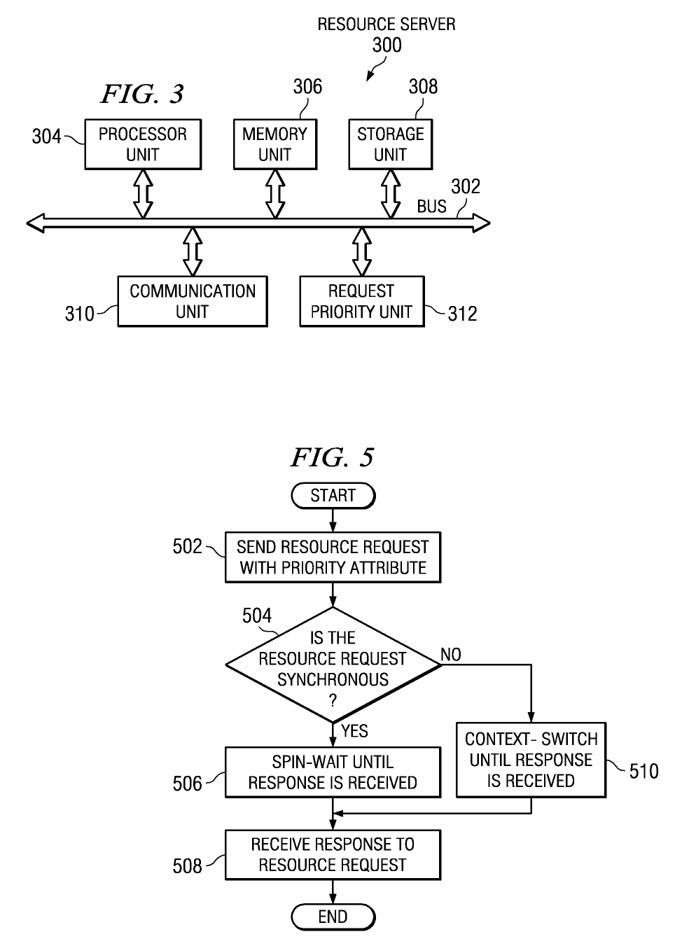

With reference now to FIG. 3, a block diagram of a data processing system is depicted in accordance with an illustrative embodiment. Resource server 300 may, for example, be implemented in resource server 106 in FIG. 1 and data processing system 200 in FIG. 2. In this illustrative example of FIG. 3, resource server 300 utilizes a bus architecture, such as bus 302. Bus 302 may, for example, be bus 238 in FIG. 2. Bus 302 may include one or more buses. In addition, bus 302 may be implemented using any type of communication fabric or architecture that provides for a transfer of data between the different components and devices coupled to bus 302.

Resource server 300 includes processor unit 304, memory unit 306, storage unit 308, communication unit 310, and request priority unit 312, which connects to bus 302. However, it should be noted that resource server 300 is only shown for exemplary purposes and is not meant as an architectural limitation to illustrative embodiments. In other words, resource server 300 may include more or fewer components as necessary to accomplish processes of illustrative embodiments for prioritizing resource requests from an application server, such as application server 104 in FIG. 1.

Processor unit 304 provides the data processing capabilities of resource server 300. Processor unit 304 may, for example, be processing unit 206 in FIG. 2. An operating system runs on processor unit 304 and coordinates and provides control of various components within resource server 300. In addition, software applications executing on resource server 300 may run in conjunction with the operating system.

Storage unit 308 is a non-volatile data storage device that may, for example, be configured as ROM, such as ROM 224 in FIG. 2, and/or flash ROM to provide the non-volatile memory for storing the operating system and/or user-generated data. Storage unit 308 stores instructions or computer usable program code for the operating system and applications. The instructions are loaded into memory unit 306 for execution by processor unit 304. Processor unit 304 performs processes of illustrative embodiments by executing the computer usable program code that is loaded into memory unit 306. Memory unit 306 may, for example, be main memory 208 in FIG. 2.

Resource server 300 uses communication unit 310 to communicate with other data processing systems, such as the application server, via a network, such as network 102 in FIG. 1. Communication unit 310 may include one or more devices used to transmit and receive data. For example, communication unit 310 may include a network adapter and/or a modem, such as, for example, network adapter 212 and modem 222 in FIG. 2, to send and receive wire and wireless transmissions.

Resource server 300 uses request priority unit 312 to receive resource requests from application servers and/or clients, such as clients 110, 112, and 114 in FIG. 1. In addition, resource server 300 uses request priority unit 312 to prioritize the resource requests in a queue according to priority attributes associated with each of the resource requests. After prioritizing the resource requests in the queue, request priority unit 312 selects and processes the resource request with the highest priority in the queue. Subsequent to processing the selected resource request, request priority unit 312 sends a response to the requester. Moreover, request priority unit 312 re-prioritizes any remaining resource requests in the queue according to priority policy after processing the resource request.

It should be noted that the user or the system administrator of resource server 300 may enable and disable request priority unit 312 independently of other components of resource server 300. Further, it should be noted that request priority unit 312 may be implemented entirely as software, hardware, or a combination of software and hardware components. Furthermore, even though the exemplary illustration of FIG. 3 depicts resource server 300 to include request priority unit 312, request priority unit 312 may, for example, reside in another data processing system, such as the application server or clients.

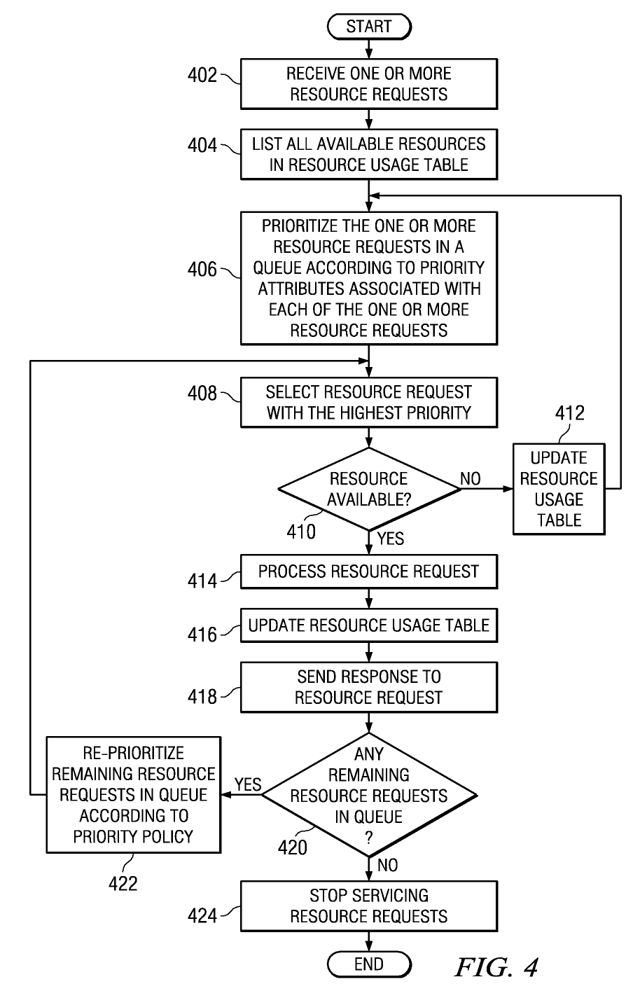

With reference now to FIG. 4, a flowchart illustrating an exemplary process for prioritizing resource requests is shown in accordance with an illustrative embodiment. The process shown in FIG. 4 may be implemented in a resource server, such as, for example, resource server 300 in FIG. 3.

The process begins when the resource server uses a request priority unit, such as, for example, request priority unit 312 in FIG. 3, to receive one or more resource requests from an application server or clients, such as, for example, application server 104 and clients 110, 112, and 114 in FIG. 1 (step 402). It should be noted that the request priority unit may continue to receive resource requests as the process proceeds forward from step 402. Subsequent to, or concurrent with, receiving the one or more resource requests in step 402, the request priority unit lists all available resources in a resource usage table (step 404). The resource usage table is an updatable table of currently available resources.

Subsequent to, or concurrent with, listing all available resources in step 404, the request priority unit prioritizes the one of more resource requests in a queue according to the priority attribute associated with each of the one or more resource requests (step 406). The requester that issues the resource request associates the priority attribute with the resource request. The priority attribute indicates whether the resource request is synchronous or asynchronous.

After prioritizing the one or more resource requests in the queue, the request priority unit selects a resource request with the highest priority in the queue (step 408). Subsequent to selecting the resource request with the highest priority in step 408, the request priority unit makes a determination as to whether the resource is currently available (step 410). The request priority unit determines that the resource is currently available by, for example, checking the resource usage table. If the requested resource is not currently available, no output of step 410, then the request priority unit updates the resource usage table by indicating in the table that the resource was not currently available (step 412). Subsequent to, or concurrent with, updating the resource usage table in step 412, the process returns to step 406 where the request priority unit returns and prioritizes the resource request in the queue.

Returning now to step 410, if the requested resource is currently available, yes output of step 410, then the request priority unit processes the resource request (step 414). Subsequent to, or concurrent with, processing the resource request in step 414, the request priority unit updates the resource usage table by indicating in the table that the resource was granted to the requester and is currently unavailable (step 416). Subsequent to, or concurrent with, updating the resource usage table in step 416, the request priority unit sends a response to the resource request from the resource server to the requester within the application server (step 418).

After sending the response in step 418, the request priority unit makes a determination as to whether any other resource requests remain in the queue (step 420). If more resource requests remain in the queue, yes output of step 420, then the request priority unit re-prioritizes the remaining resource requests in the queue according to priority policy (step 422). The priority policy may, for example, increase priority of spin-wait resource requests, decrease priority of context-switch resource requests, and increase priority of long-waiting resource requests. Subsequent to re-prioritizing the remaining resource requests in the queue in step 422, the process returns to step 408 where the request priority unit selects the resource request with the highest priority in the queue.

Returning now to step 420, if no more resource requests remain in the queue, no output of step 420, then the request priority unit stops servicing resource requests (step 424). Although the flowchart indicates that the process ends thereafter, the resource server never actually ceases to function but rather goes into a dormant state waiting to receive one or more resource requests at step 402 where the process begins again. In addition, it should be noted that for the sake of simplicity the process of FIG. 4 neither shows releasing a resource by the application server after the resource server services a request from the application server nor blocking one or more other requests, which seek to access the same resource, by the application server while the resource server services the request. However, the resource server may use the releasing process and blocking process information to update the status of the resource in the resource usage table from unavailable to available or available to unavailable, respectively.

With reference now to FIG. 5, a flowchart illustrating an exemplary process for sending a resource request is shown in accordance with an illustrative embodiment. The process shown in FIG. 5 may be implemented in an application server, such as, for example, application server 104 in FIG. 1.

The process begins when an application or thread executing within the application server sends a resource request to a resource server, such as, for example, resource server 106 in FIG. 1, via a network, such as, for example, network 102 in FIG. 1 (step 502). The application or thread, which issues the resource request, associates a priority attribute with the resource request prior to sending the resource request to the resource server. Subsequent to sending the resource request in step 502, the application server makes a determination as to whether the sent resource request is a synchronous resource request (step 504).

If the sent resource request is synchronous, yes output of step 504, then the application or thread, which issued the resource request, spin-waits until the application or thread receives a response from the resource server (step 506). After spin-waiting in step 506, the application or thread receives the response from the resource server (step 508). The process terminates thereafter.

Returning now to step 504, if the sent resource request is not synchronous, or asynchronous, no output of step 504, then the application or thread, which issued the resource request, context-switches until the application or thread receives a response from the resource server (step 510). After context-switching in step 510, the process returns to step 508 where the application or thread receives the response.

Thus, illustrative embodiments provide a computer implemented method, system, and computer usable program code for prioritizing resource requests. The illustrative embodiments can take the form of an entirely hardware embodiment, an entirely software embodiment or an embodiment containing both hardware and software elements. The illustrative embodiments are implemented in software, which includes but is not limited to firmware, resident software, microcode, etc.

Furthermore, the illustrative embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, RAM, a read-only memory (ROM), a rigid magnetic disk and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the illustrative embodiments have been presented for purposes of illustration and description, and is not intended to be exhaustive or limited to the illustrative embodiments in the form disclosed. Many modifications and variations will be apparent to those of ordinary skill in the art. The embodiment was chosen and described in order to best explain the principles of the illustrative embodiments, the practical application, and to enable others of ordinary skill in the art to understand the illustrative embodiments for various embodiments with various modifications as are suited to the particular use contemplated.

What is claimed is:

1. A computer implemented method for prioritizing resource requests, the computer implemented method comprising:
receiving one or more resource requests;
prioritizing the one or more resource requests in a queue according to a priority attribute associated with each of the one or more resource requests;
responsive to selecting a resource request with a highest priority in the queue, processing the resource request with the highest priority; and
sending a response to the resource request with the highest priority.

2. The computer implemented method of claim 1, further comprising:
re-prioritizing remaining resource requests in the queue according to a priority policy after processing the resource request with the highest priority.

3. The computer implemented method of claim 1, wherein a requester associates the priority attribute with the one or more resource requests.

4. The computer implemented method of claim 3, wherein the requester is an application.

5. The computer implemented method of claim 3, wherein the requester is a thread of a multi-threaded application, and wherein the multi-threaded application resides in an application server.

6. The computer implemented method of claim 5, wherein the receiving, prioritizing, selecting, processing, sending, and re-prioritizing steps are performed within a resource server, and wherein the resource server utilizes a request priority unit to execute the steps, and wherein the resource server is coupled to the application server via a network.

7. The computer implemented method of claim 2, wherein the priority attribute identifies each of the one or more resource requests as one of a synchronous resource request or an asynchronous resource request.

8. The computer implemented method of claim 7, wherein the synchronous resource request is a spin-wait resource request, and wherein the asynchronous resource request is a context-switch resource request.

9. The computer implemented method of claim 8, wherein the spin-wait resource request holds processor cycles until the response is received, and wherein the context-switch resource request cedes processor cycles immediately after sending the context-switch resource request until the response is received.

10. The computer implemented method of claim 8, wherein the priority policy includes increasing priority of spin-wait resource requests, decreasing priority of context-switch resource requests, and increasing priority of long-waiting resource requests.

11. A data processing system for prioritizing resource requests, comprising:
a bus system;
a storage device connected to the bus system, wherein the storage device includes a set of instructions; and
a processing unit connected to the bus system, wherein the processing unit executes the set of instructions to receive one or more resource requests, prioritize the one or more resource requests in a queue according to a priority attribute associated with each of the one or more resource requests, process a resource request with a highest priority in response to selecting the resource request with the highest priority in the queue, and send a response to the resource request with the highest priority.

12. The data processing system of claim 11, wherein the processing unit executes a further set of instructions to re-prioritize remaining resource requests in the queue according to a priority policy after processing the resource request with the highest priority.

13. The data processing system of claim 12, wherein the set of instructions to receive, prioritize, process, and send and the further set of instructions to re-prioritize are performed within a resource server, and wherein the resource server utilizes a request priority unit to execute the set of instructions and further set of instructions, and wherein the resource server is coupled to an application server via a network.

14. The data processing system of claim 11, wherein a spin-wait resource request holds processor cycles until the response is received, and wherein a context-switch resource request cedes processor cycles immediately after sending the context-switch resource request until the response is received.

15. A computer program product for prioritizing resource requests, the computer program product comprising:
a computer usable medium having computer usable program code embodied therein, the computer usable medium comprising:
computer usable program code configured to receive one or more resource requests;
computer usable program code configured to prioritize the one or more resource requests in a queue according to a priority attribute associated with each of the one or more resource requests;
computer usable program code configured to process a resource request with a highest priority in response to selecting the resource request with the highest priority in the queue; and
computer usable program code configured to send a response to the resource request with the highest priority.

16. The computer program product of claim 15, further comprising:
computer usable program code configured to re-prioritize remaining resource requests in the queue according to a priority policy after processing the resource request with the highest priority.

17. The computer program product of claim 15, wherein a requester associates the priority attribute with the one or more resource requests.

18. The computer program product of claim 16, wherein the priority attribute identifies each of the one or more resource requests as one of a synchronous resource request or an asynchronous resource request.

19. The computer program product of claim 18, wherein the synchronous resource request is a spin-wait resource request, and wherein the asynchronous resource request is a context-switch resource request.

20. The computer program product of claim 19, wherein the priority policy includes increasing priority of spin-wait resource requests, decreasing priority of context-switch resource requests, and increasing priority of long-waiting resource requests.
